(19) United States
(12) Patent Application Publication
(10) Pub. No.: US 2006/0088123 A1
(43) Pub. Date: Apr. 27, 2006

(54) Method and system for Gaussian filter modification for improved modulation characteristics in Bluetooth RF transmitters

(76) Inventors: Henrik Tholstrup Jensen, Long Beach, CA (US); Brima Ibrahim, Aliso Viejo, CA (US)

Correspondence Address: MCANDREWS HELD & MALLOY, LTD, 500 WEST MADISON STREET, SUITE 3400, CHICAGO, IL, 60661, US

(21) Appl. No.: 11/059,213

(22) Filed: Feb. 16, 2005

Related U.S. Application Data
(60) Provisional application No. 60/621,214, filed on Oct. 21, 2004.

(51) Int. Cl. H04L 27/04

(52) U.S. Cl. 375/295

(57) ABSTRACT

Certain aspects of the invention may comprise determining an impulse response of a first Gaussian filter based on a filter length and an oversampling ratio (OSR). The most significant coefficients of the first Gaussian filter may be modified to create a target filter. An upper limit and a lower limit for deviation of the modified most significant coefficients for the target filter may be determined. A magnitude response for the target filter may be constrained based on at least a selected corner frequency, which is related to the OSR. A line search algorithm may be executed on the constrained magnitude response to generate new coefficients for the target filter.

### CROSS-REFERENCE TO RELATED APPLICATIONS/INCORPORATION BY REFERENCE

This patent application makes reference to, claims priority to and claims benefit from U.S. Provisional Patent Application Ser. No. 60/621,214 (Attorney Docket No. 16239US01) filed on Oct. 21, 2004.

This application also makes reference to U.S. Application Ser. No. 10/816,731 filed on Apr. 4, 2004.

The above referenced applications are hereby incorporated herein by reference in their entirety.

### FIELD OF THE INVENTION

Certain embodiments of the invention relate to RF transmitters. More specifically, certain embodiments of the invention relate to a method and system for Gaussian filter modification for improved modulation characteristics in Bluetooth RF transmitters.

### BACKGROUND OF THE INVENTION

Modern wireless RF transmitters for applications such as cellular, personal, and satellite communications employ digital modulation schemes such as frequency shift keying (FSK) and phase shift keying (PSK), and variants thereof, often in combination with code-division multiple-access (CDMA) communication or other multiple access schemes such as time division multiple access (TDMA). Independent of the particular communications scheme employed, the RF transmitter output signal, s_{RF}(t), may be represented mathematically as
s_{RF}(t)=r(t)cos(2πf_{c}t+θ(t)), (1)
where f_{c} denotes the RF carrier frequency, and the signal components r(t) and θ(t) are referred to as the envelope and phase of s_{RF}(t), respectively.

Some of the above mentioned communication schemes may have a constant envelope, for example,
r(t)=R, where R is a constant. (2)

Such communication schemes may be referred to as constant-envelope communications schemes, wherein θ(t) may constitute the information bearing part of a transmitted signal. Other communications schemes may have envelopes that vary with time and may be referred to as variable-envelope communications schemes, wherein both r(t) and θ(t) may constitute the information bearing parts of a transmitted signal.

The most widespread standard in wireless personal area network (PAN) communications is currently Bluetooth 1.1. This standard employs Gaussian minimum shift keying (GMSK), a constant-envelope binary modulation scheme, with a maximum raw transmission rate of 1 Megabits per second (Mbps). In a mobile communication system, the radio spectrum may be a limited resource that is shared by all users. Bluetooth employs a frequency-hopping scheme for the purpose of sharing the spectrum resource and to increase robustness towards undesired interference. Bluetooth devices operate in the 2.4 GHz unlicensed industrial, scientific, and medical (ISM) band and may occupy an RF channel bandwidth of 1 MHz, for example. While Bluetooth 1.1 may be sufficient for standard voice and data services, future high-fidelity audio and data services may demand higher data throughput rates.

Higher data rates may be achieved by selectively applying either an 8-level PSK (8-PSK) or a pi/4-offset, 4-level PSK (pi/4-offset QPSK) modulation scheme, as illustrated in the specification of the latest enhancement of Bluetooth, the Bluetooth Enhanced Data Rate (EDR) standard. The maximum bit rate may be tripled by utilizing an 8-level PSK (8-PSK) modulation scheme and the maximum bit rate may be doubled by utilizing a 4-level PSK (pi/4-offset QPSK) modulation scheme compared to Bluetooth 1.1. A chosen pulse shaping may ensure that the RF carrier bandwidth is the same as that of Bluetooth 1.1 allowing for reuse of radio channels and backwards compatibility.

With the introduction of such multi-mode communications standards, a need arises for a modulator capable of switching modulation modes with continuous amplitude and continuous phase modulation in order to support both frequency shift keying (FSK) and phase shift keying (PSK) modulation within a data packet. When transmitting data packets, Bluetooth EDR specifies that all devices initially employ legacy GFSK modulation. If both transmitter and receiver are capable thereof, modulation may be switched to PSK within the packet in order to provide higher throughput. Such a need for continuous modulation mode switching may arise from the requirement that during a transition between two modulation formats, a transmitted RF spectrum must comply with strict spectral mask limitations set by applicable regulatory bodies. Typically, such requirements cannot be met when modulation switching occurs with abrupt, discontinuous waveforms.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

A system and/or method for Gaussian filter modification for improved modulation characteristics in Bluetooth RF transmitters, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates a block diagram of an exemplary Bluetooth RF transmitter, which may be utilized in connection with an embodiment of the invention.

FIG. 2 illustrates details of the exemplary digital modulator block of FIG. 1, for example, which may be utilized in connection with an embodiment of the invention.

FIG. 3 is a graph illustrating a constant envelope waveform, which may be generated by the power amplifier of the transmitter, in accordance with an embodiment of the invention.

FIG. 4 is a graph illustrating a variable envelope waveform, which may be generated by the power amplifier of the transmitter, in accordance with an embodiment of the invention.

FIG. 5 is a graph illustrating an output waveform of the interpolation filter block of FIG. 2, for example, when the transmitter switches from FSK to PSK modulation and back to FSK modulation, which may be utilized in connection with an embodiment of the invention.

FIG. 6 is a graph illustrating an output waveform of the pulse shaping block of FIG. 2, for example, when the transmitter switches from FSK to PSK modulation and back to FSK modulation, which may be utilized in connection with an embodiment of the invention.

FIG. 7 is a graph illustrating an output waveform of the phase accumulator block of FIG. 2, for example, when the transmitter switches from FSK to PSK modulation and back to FSK modulation, which may be utilized in connection with an embodiment of the invention.

FIG. 8 is a graph illustrating an in-phase channel (I-channel) output waveform of the 4×2 multiplexer (Mux) block of FIG. 2, for example, when the transmitter switches from FSK to PSK modulation and back to FSK modulation, which may be utilized in connection with an embodiment of the invention.

FIG. 9 is a graph illustrating a quadrature channel (Q-channel) output waveform of the 4×2 multiplexer (Mux) block of FIG. 2, for example, when the transmitter switches from FSK to PSK modulation and back to FSK modulation, which may be utilized in connection with an embodiment of the invention.

FIG. 10 is a graph illustrating the discrete-time impulse response waveform of an example Gaussian filter for the digital modulator of FIG. 1, for example, which may be utilized in connection with an embodiment of the invention.

FIG. 11 is a graph illustrating a magnitude response waveform of the Gaussian filter of FIG. 10, for example, which may be utilized in connection with an embodiment of the invention.

FIG. 12 is a graph illustrating a demodulated test-sequence-1 data waveform for a transmitter with a conventional Gaussian filter, for example, which may be utilized in connection with an embodiment of the invention.

FIG. 13 is a graph illustrating a demodulated test-sequence-2 data waveform for a transmitter with a conventional Gaussian filter, which may be utilized in connection with an embodiment of the invention.

FIG. 14 is a graph illustrating a demodulated random data waveform for a transmitter with a conventional Gaussian filter, which may be utilized in connection with an embodiment of the invention.

FIG. 15 is a graph illustrating the RF output signal power spectrum waveform corresponding to random data for a transmitter with a conventional Gaussian filter, which may be utilized in connection with an embodiment of the invention.

FIG. 16 is a graph illustrating a worst-case modulation characteristics waveform for a transmitter employing a Gaussian filter with DC offsets in the in-phase path (I), which may be utilized in connection with an embodiment of the invention.

FIG. 17 is a graph illustrating a worst-case modulation characteristics waveform for a transmitter employing a Gaussian filter with DC offsets in the quadrature path (Q), which may be utilized in connection with an embodiment of the invention.

FIG. 18 is a graph illustrating an impulse response waveform of the conventional Gaussian filter and an impulse response waveform of an example modified Gaussian filter, which may be utilized in connection with an embodiment of the invention.

FIG. 19 is a graph illustrating a magnitude response waveform of an example modified Gaussian filter of FIG. 19, for example, in accordance with an embodiment of the invention.

FIG. 20 is a graph illustrating a magnitude response waveform of the conventional Gaussian filter and a magnitude response waveform of an example modified Gaussian filter, which may be utilized in connection with an embodiment of the invention.

FIG. 21 is a graph illustrating a demodulated test-sequence-1 data waveform for a transmitter with a Gaussian filter modified in accordance with an embodiment of the present invention.

FIG. 22 is a graph illustrating a demodulated test-sequence-2 data waveform for a transmitter with a Gaussian filter modified in accordance with an embodiment of the present invention.

FIG. 23 is a graph illustrating a demodulated random data waveform for a transmitter with a Gaussian filter modified in accordance with an embodiment of the present invention.

FIG. 24 is a graph illustrating the RF output signal power spectrum waveform corresponding to random data for a transmitter with a Gaussian filter modified in accordance with an embodiment of the present invention.

FIG. 25 is a graph illustrating a demodulated test-sequence-1 data waveform for a transmitter with a Gaussian filter modified in accordance with an embodiment of the present invention.

FIG. 26 is a graph illustrating a demodulated test-sequence-2 data waveform for a transmitter with a Gaussian filter modified in accordance with an embodiment of the present invention.

FIG. 27 is a flowchart illustrating exemplary steps that may be utilized for Gaussian filter modification, in accordance with an embodiment of the invention.

### DETAILED DESCRIPTION OF THE INVENTION

Certain aspects of the invention may comprise determining an impulse response of a first Gaussian filter based on a filter length and an oversampling ratio (OSR). In accordance with an embodiment of the invention, the most significant coefficients of the first Gaussian filter may be modified to create a target filter. An upper limit and a lower limit for deviation of the modified most significant coefficients for the target filter may be determined. A magnitude response for the target filter may be constrained based on at least a selected corner frequency, which is related to the OSR. A line search algorithm may be executed on the constrained magnitude response to generate new coefficients for the target filter.

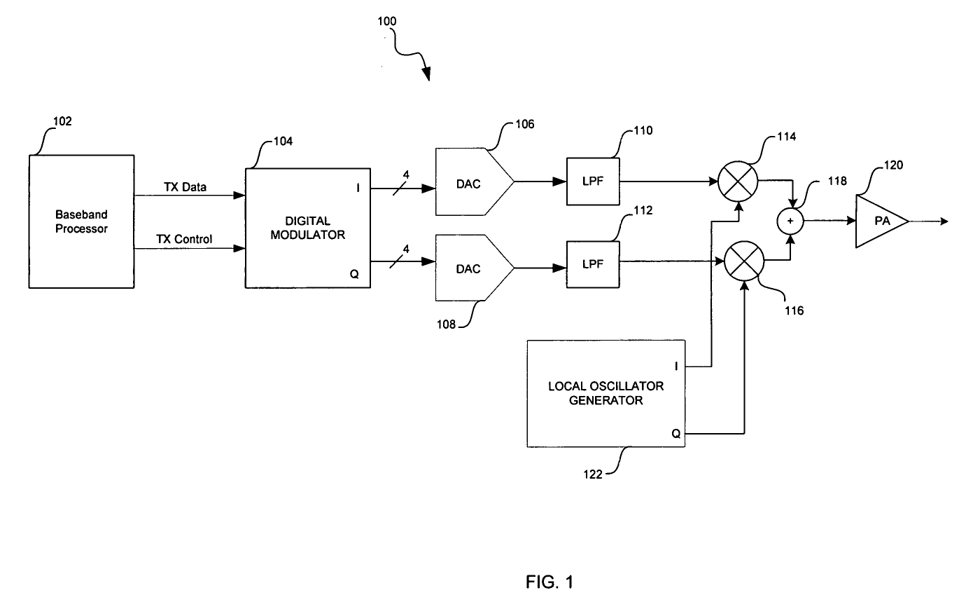

FIG. 1 illustrates a block diagram of an exemplary Bluetooth RF transmitter, which may be utilized in connection with an embodiment of the invention. Referring to FIG. 1, there is shown an RF transmitter 100. The RF transmitter 100 may comprise a baseband processor 102, a digital modulator 104, a plurality of digital to analog converters (DACs) 106 and 108, a plurality of low pass filters (LPFs) 110 and 112, a plurality of mixers 114 and 116, a summer 118, a power amplifier (PA) 120 and a local oscillator (LO) generator 122.

The baseband processor 102 may comprise suitable logic, circuitry and/or code that may be adapted to generate a TX data signal and a TX timing control signal. The baseband processor 102 may be, for example, an ARM processor or other suitable type of processor, which may be adapted to produce output signals, which comprise corresponding I and Q components. The baseband processor 102 may provide a digital platform for baseband processing functions, which may comprise analog, and digital GSM/GPRS/EDGE baseband processing functions on a single CMOS chip.

The digital modulator 104 may comprise suitable logic, circuitry and/or code that may be adapted to receive a plurality of input signals from the baseband processor 102 and modulate the received signals to a suitable carrier frequency. The DACs 106 and 108 may be adapted to convert digitized signals, for example, 4-bit signals to analog signals in the I and Q channels respectively. The low pass filters 110 and 112 may comprise suitable logic, circuitry and/or code that may be adapted to inhibit aliasing and eliminate unwanted high frequency noise from the analog signals.

The mixer 114 may comprise suitable logic, circuitry, and/or code that may be adapted to mix an output of the LPF 110 with the local oscillator frequency (f_{LO}) to produce a zero intermediate frequency (IF) “I” signal component. The “I” signal component may be a differential signal, for example. The mixer 116 may comprise suitable logic, circuitry, and/or code that may be adapted to mix the output of the LPF 112 with a local oscillator frequency (f_{Lo}) to produce a zero IF “Q” signal component. The “Q” quadrature signal component may be a differential signal, for example.

The summer 118 may comprise suitable logic, circuitry, and/or code that may be adapted to sum the input signals received from the plurality of mixers 114 and 116 and generate an output signal to the power amplifier (PA) 120. The power amplifier (PA) 120 may comprise suitable logic, circuitry, and/or code that may be adapted to amplify the signal received from the summer 118 and generate an amplified output signal.

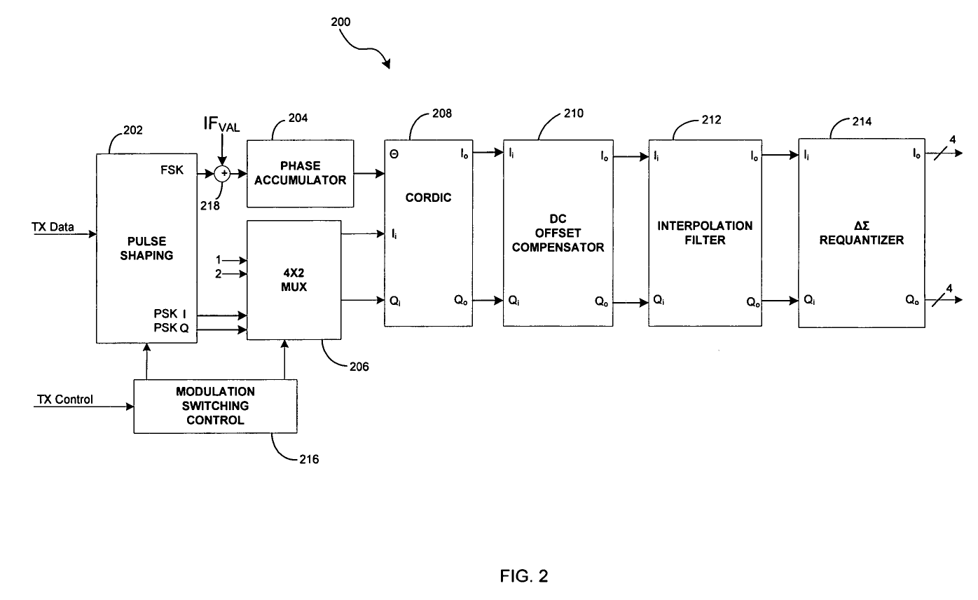

FIG. 2 illustrates details of the exemplary digital modulator block 104 of FIG. 1, for example, which may be utilized in connection with an embodiment of the invention. Referring to FIG. 2, there is shown a digital modulator block 200. The digital modulator block 200 may comprise a pulse shaping block 202, a summer 216, a phase accumulator block 204, a 4×2 multiplexer (Mux) 206, a coordinate rotation digital computer (CORDIC) block 208, a DC offset compensator 210, an interpolation filter 212, a delta sigma requantizer block 214 and a modulation switching control block 216.

The pulse shaping block 202 may comprise suitable logic, circuitry and/or code that may be adapted to employ a plurality of digital filters that may be utilized to perform pulse shape filtering of the transmitter symbols, as defined by the communications standard. In accordance with the Bluetooth (BT) Enhanced Data Rate (EDR) standard, pulse shaping for Gaussian frequency shift keying (GFSK) mode may be performed by utilizing a Gaussian filter (GF) with a bandwidth—symbol time (BT) product of 0.5, for example, and pulse shaping for phase shift keying (PSK) mode may be performed by utilizing a square root raised cosine filter (SRRCF) with a roll-off factor of 0.4, for example. The RF transmitter may be adapted to support zero and low IF modulation.

The phase accumulator block 204 may comprise suitable logic, circuitry and/or code that may be adapted to receive an input signal from the summer 218 and generate an output signal Θ to the CORDIC block 208. The desired IF frequency may be determined by a constant frequency IF_{VAL}. In frequency shift keying (FSK) mode, the real-valued symbols from a set {+1, −1} may enter the GF and a resulting continuous waveform, along with a desired IF_{VAL} may be accumulated in the phase accumulator block 204. The CORDIC block 208 may comprise suitable logic, circuitry and/or code that may be adapted to receive a plurality of input signals from the phase accumulator block 204, for example, output Θ and the 4×2 Mux 206, for example, outputs Iᵢ and Qᵢ. The CORDIC block 208 may comprise suitable logic, circuitry and/or code that may be adapted to generate the FSK signal at the desired IF frequency by rotating a basis vector (Real, Imag)=(1,0) by an angle Θ. In PSK mode, the complex symbols e^{jΦ}^{ₖ}, where,

$$R e \{ {ⅇ}^{{jΦ}_{k}} \} ∈ \{ 0 , \frac{1}{\sqrt{2}} , 1 , - \frac{1}{\sqrt{2}} , - 1 \} Im \{ {ⅇ}^{{jΦ}_{k}} \} ∈ \{ 0 , \frac{1}{\sqrt{2}} , 1 , - \frac{1}{\sqrt{2}} , - 1 \} \qquad ( 3 )$$

may enter the SRRCF and a resulting continuous complex waveform may be translated to a desired IF frequency using the CORDIC block 208. During this mode, the FSK output of the pulse shaping block 202 may be zero and the phase accumulator block 204 output may be a phase ramp, corresponding to the desired IF frequency.

The summer 218 may comprise suitable logic, circuitry and/or code that may be adapted to receive an FSK output signal from the pulse shaping block 202 and a constant signal IF_{VAL} and generate a summed output to the phase accumulator block 204. The 4×2 Mux may comprise suitable logic, circuitry and/or code that may be adapted to receive a plurality of signals in FSK and PSK mode and generate in-phase (I) and quadrature (Q) output signals Iᵢ and Qᵢ respectively, to the CORDIC block 208. The DC offset compensator block 210 may comprise suitable logic, circuitry and/or code that may be adapted to compensate the transmitter for known DC offsets and gain and phase imbalances (I-Q imbalance).

The interpolation filter block 212 may comprise suitable logic, circuitry and/or code that may be adapted to receive in-phase (I) and quadrature (Q) input components Iᵢ and Qᵢ respectively, and generate in-phase (I) and quadrature (Q) output components Iₒ and Qₒ respectively, to the delta sigma requantizer block 214. The interpolation filter block 212 may be adapted to increase the sampling rate from 24 MHz to 96 MHz, for example. The delta sigma requantizer block 214 may comprise suitable logic, circuitry and/or code that may be adapted to quantize the digital modulator output to 4 bits, for example. This 4-bit signal may be adapted to drive the transmitter DACs 106 and 108. The modulation switching control block 216 may comprise suitable logic, circuitry and/or code that may be adapted to receive a TX control signal and generate a plurality of output signals to the pulse shaping block 202 and the 4×2 Mux 206.

In operation, TX data may be received by the pulse shaping block 202 based on a data rate for the current operational mode. For 1 Mbps data rates, for example, TX data may be one bit wide, 2 bits wide for 2 Mbps data rates, for example, and 3 bits wide for 3 Mbps data rates, for example. The bits may be received in parallel over a plurality of lines or traces or in logical groups. For the 3-bit wide data, 3 sequential bits, for example, received serially may be part of one value that is to be modulated into an 8-PSK symbol. The pulse shaping block 202 may be adapted to modulate the 1 bit wide 1 Mbps, for example, TX data in FSK and may be adapted to modulate the 2 and 3 bit wide data for the 2 Mbps and 3 Mbps data rates, for example, in PSK. The pulse shaping block 202 may be adapted to employ a plurality of digital filters to perform pulse shape filtering of the transmitter symbols. The pulse shaping block 202 may be adapted to limit the spectrum of the energy that may be emitted in the RF band. In FSK, the amplitude may be constant and the phase or frequency may change to reflect the data. For example, for the Bluetooth medium rate standard (BMRS), the pulse shaping for FSK mode may be performed by utilizing a Gaussian filter (GF) with a BT product of 0.5, for example, and pulse shaping for PSK may be performed by utilizing a square root raised cosine filter (SRRCF) with a roll-off factor of 0.4, for example.

The modulation to a desired IF frequency may occur cumulatively as the data is being processed through the pulse shaping block 202, the phase accumulator block 204, the 4×2 Mux 206 and the CORDIC block 208. The desired IF frequency may be determined by the constant IF_{VAL}. In FSK mode, the symbols may enter the GF within pulse shaping block 202 and a resulting continuous waveform, along with a desired IF_{VAL} may be accumulated in the phase accumulator block 204. The CORDIC block 208 may utilize the phase accumulator block 204 output Θ to generate the FSK signal at the desired IF frequency by rotating a basis vector (Real, Imag)=(1,0) by the angle Θ.

When the transmitter is in an FSK mode of operation, which may be specified by a mode control signal generated by the modulation control block 214, the I and Q inputs to the CORDIC block 208 may be 1 and 0, respectively. According to a phase value received at the Θ input of the CORDIC block 118, the vector may be rotated from the base position. The I and Q outputs of the CORDIC block 208, may reflect Cartesian coordinates of the rotated vector. The CORDIC block 208 may be adapted to rotate a signal around a unit circle according to a received phase value. The I and Q components generated by the CORDIC block 208 may be continuously and smoothly varying thereby avoiding spectral leakage caused by abrupt transitions.

The rotated vector of the CORDIC block 208 may be output to the DC offset compensation block 210, which may be adapted to pre-compensate for DC components that may be introduced downstream to effectively counteract low DC signals. The pre-compensated signals produced by DC offset compensation block 210 may be output to the interpolation filter block 212, which may be adapted to upsample the output of the DC offset compensation block 210 to produce an upsampled output. The upsampled output may be received by the delta sigma requantizer block 214, which may be adapted to reduce the granularity of the interpolated data received from the interpolation filter block 212. The reduced granularity of the data may reduce the required complexity of downstream digital-to-analog converters.

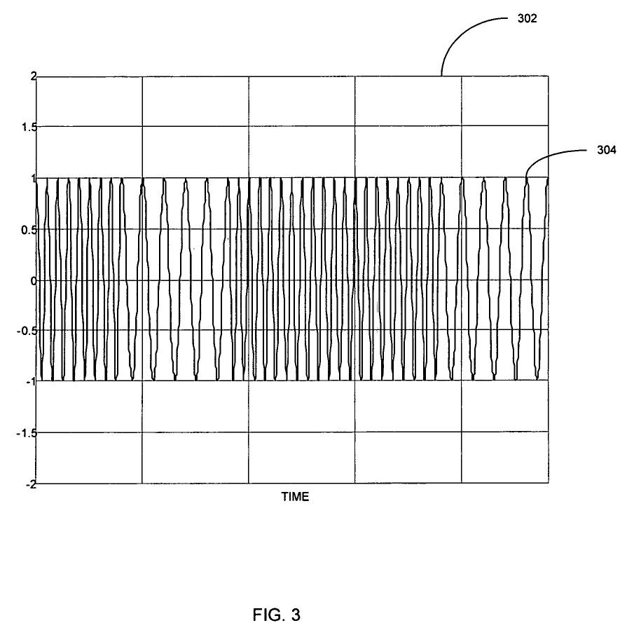

FIG. 3 is a graph 302 illustrating a constant envelope waveform 304, which may be generated by the power amplifier 120 of the transmitter 100, in accordance with an embodiment of the invention. Referring to FIG. 3, the constant envelope waveform 304 may be generated by the power amplifier 120 while operating in GFSK mode.

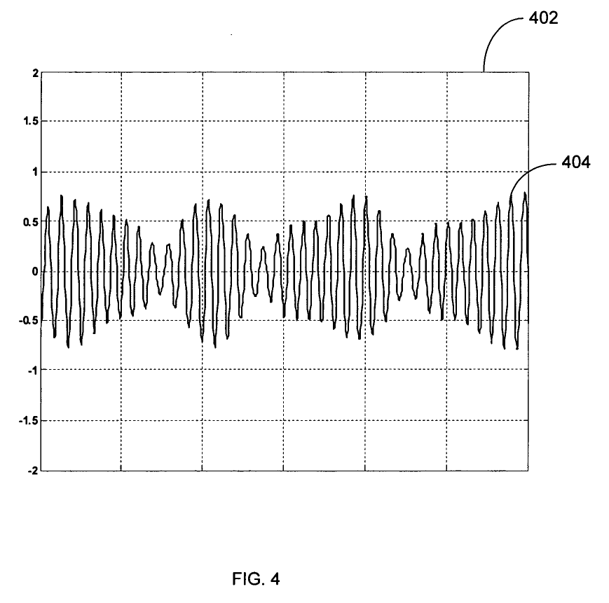

FIG. 4 is a graph 402 illustrating a variable envelope waveform 404, which may be generated by the power amplifier 120 of the transmitter 100, in accordance with an embodiment of the invention. Referring to FIG. 4, the variable envelope waveform 404 may be generated by the power amplifier 120 while operating in PSK mode.

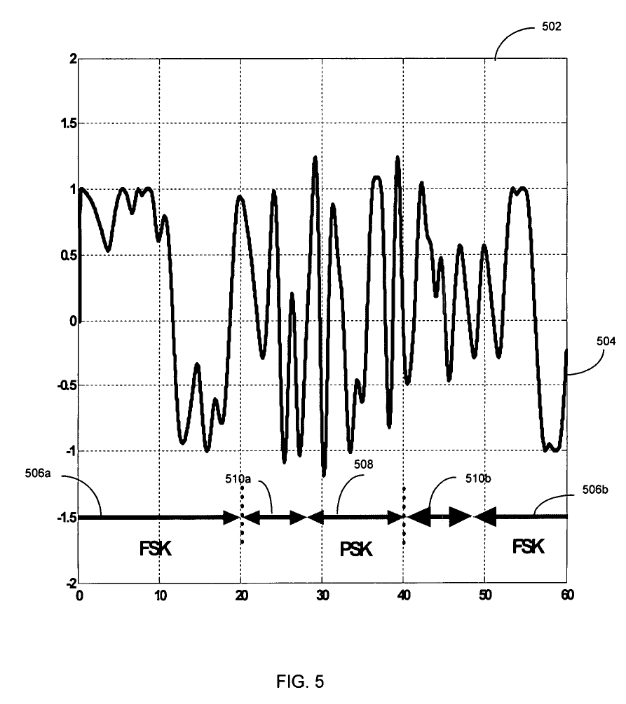

FIGS. 5 through 9 illustrate the effectiveness of the described circuitry when the transmitter switches from FSK to PSK modulation and back to FSK modulation, which may be utilized in connection with an embodiment of the invention. For example, the transmitter may operate in FSK mode for the first 20 μs (microseconds), then switch to PSK mode for 20 μs, for example, and then switch back to FSK mode for 20 μs, for example. The guard times define the amount of time needed for the modulator output to be valid for PSK or FSK modulation. The guard times may depend upon the pulse shaping filters employed.

FIG. 5 is a graph 502 illustrating an output waveform 504 of the interpolation filter block 212 of FIG. 2, for example, when the transmitter switches from FSK to PSK modulation and back to FSK modulation, which may be utilized in connection with an embodiment of the invention. The output amplitude may be normalized to unity for FSK mode. The dotted vertical lines may indicate switching times. The arrows 506a and 506b may indicate the transmitter in FSK modulation mode, while the arrow 508 may indicate the transmitter in PSK modulation mode. The arrows 510a and 510b may indicate guard times. FIG. 5 illustrates an output waveform 504 of the interpolation filter block 212 of FIG. 2 for the I channel and the output of the interpolation filter block 212 for the Q channel may behave similarly.

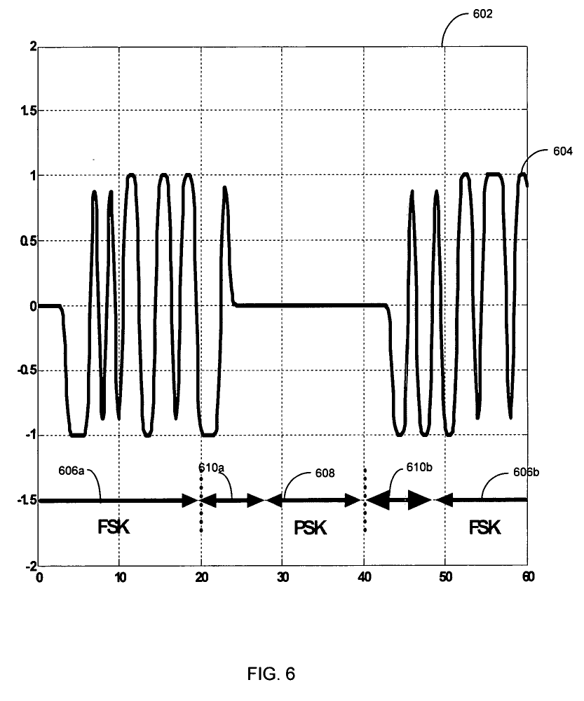

FIG. 6 is a graph 602 illustrating an output waveform 604 of the pulse shaping block 202 of FIG. 2, for example, when the transmitter switches from FSK to PSK modulation and back to FSK modulation, which may be utilized in connection with an embodiment of the invention. The output amplitude may be normalized to unity for FSK mode. The dotted vertical lines may indicate switching times. The arrows 606a and 606b may indicate the transmitter in FSK modulation mode, while the arrow 608 may indicate the transmitter in PSK modulation mode. The arrows 610a and 610b may indicate guard times. FIG. 6 illustrates an output waveform 604 of the pulse shaping block 202 of FIG. 2 for the I channel and the output of the pulse shaping block 202 for the Q channel may behave similarly.

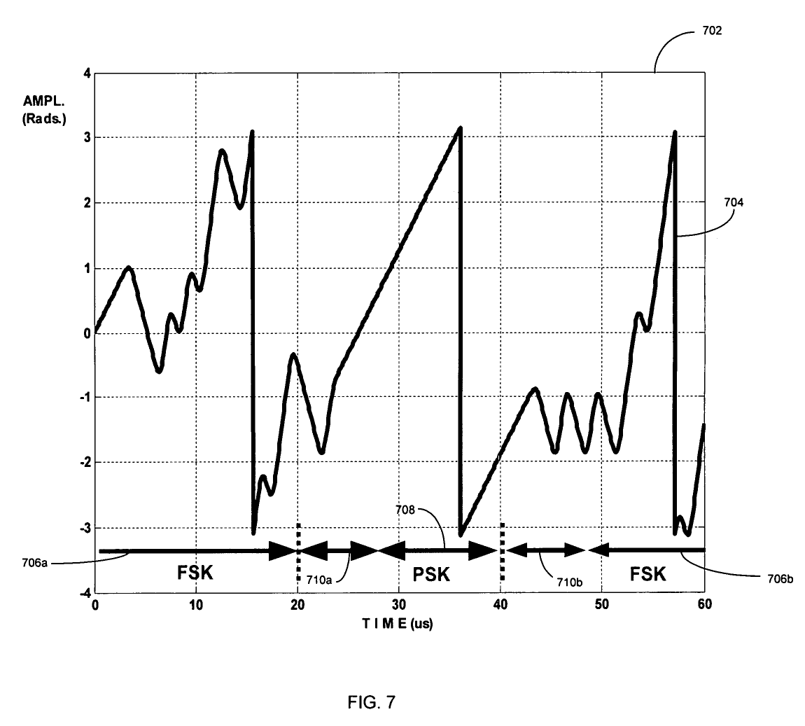

FIG. 7 is a graph 702 illustrating an output waveform 704 of the phase accumulator block 204 of FIG. 2, for example, when the transmitter switches from FSK to PSK modulation and back to FSK modulation, which may be utilized in connection with an embodiment of the invention. The output phase is shown modulo π and for IF_{VAL}>0. The dotted vertical lines may indicate switching times. The arrows 706a and 706b may indicate the transmitter in FSK modulation mode, while the arrow 708 may indicate the transmitter in PSK modulation mode. The arrows 710a and 710b may indicate guard times. FIG. 7 illustrates an output waveform 704 of the phase accumulator block 204 of FIG. 2 for the I channel and the output of the phase accumulator block 204 for the Q channel may behave similarly.

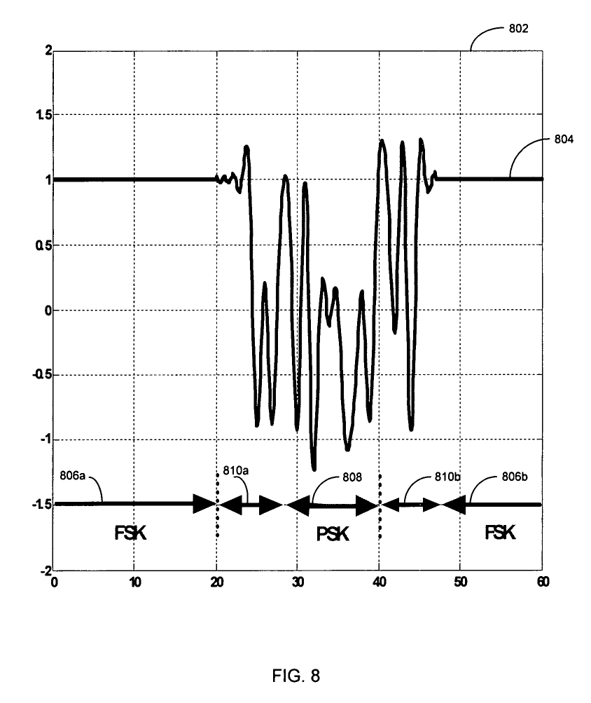

FIG. 8 is a graph 802 illustrating an in-phase channel (I-channel) output waveform 804 of the 4×2 multiplexer (Mux) block 206 of FIG. 2, for example, when the transmitter switches from FSK to PSK modulation and back to FSK modulation, which may be utilized in connection with an embodiment of the invention. The dotted vertical lines may indicate switching times. The arrows 806a and 806b may indicate the transmitter in FSK modulation mode, while the arrow 808 may indicate the transmitter in PSK modulation mode. The arrows 810a and 810b may indicate guard times.

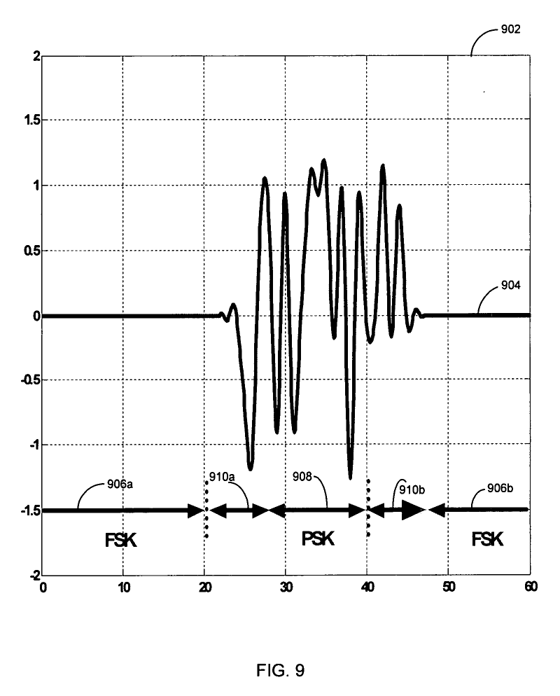

FIG. 9 is a graph 902 illustrating a quadrature channel (Q-channel) output waveform 904 of the 4×2 multiplexer (Mux) block 206 of FIG. 2, for example, when the transmitter switches from FSK to PSK modulation and back to FSK modulation, which may be utilized in connection with an embodiment of the invention. The dotted vertical lines may indicate switching times. The arrows 906a and 906b may indicate the transmitter in FSK modulation mode, while the arrow 908 may indicate the transmitter in PSK modulation mode. The arrows 910a and 910b may indicate guard times.

FIG. 9 illustrates typical behavior of the quadrature channel (Q-channel) output of the 4×2 Mux block 206 of FIG. 2 when the transmitter switches from FSK to PSK modulation and back to FSK modulation, which may be utilized in connection with an embodiment of the invention. The dotted vertical lines may indicate switching times. Green arrows may indicate the transmitter in FSK modulation mode, while red arrows may indicate the transmitter in PSK modulation mode. Black arrows may indicate guard times.

A Gaussian filter may be implemented as a finite impulse response (FIR) filter, defined by a finite sequence of filter taps h[n] and with discrete-time frequency response

$$H ( {ⅇ}^{j ω} ) = {\sum }_{i = - N}^{N} h [ n ] {ⅇ}^{- jω n} \qquad ( 4 )$$

Specifically, a Gaussian filter may be defined mathematically by its impulse response,

$$g ( t ) = \frac{1}{2} [ erf ( \frac{2 π BT ( t + 0.5 )}{\sqrt{2 log ( 2 )}} ) - erf ( \frac{2 π BT ( t - 0.5 )}{\sqrt{2 log ( 2 )}} ) ] \qquad ( 5 )$$

where erf denotes the error function.

$$erf ( t ) = \frac{2}{\sqrt{π}} {\int }_{0}^{t} {exp}^{- {x}^{2}} ⅆ x \qquad ( 6 )$$

In the digital modulator 200 (FIG. 2), the signal processing domain may be discrete-time and the filter impulse response of an even-symmetric Gaussian filter may be defined in the discrete-time domain as
h[n], n=−N, . . . , N−1, (7)
where 2N is the length of the filter or the number of filter taps. In a transmitter, the pulse shaping filter may be typically employed as an interpolation filter 212. For a filter operating at an over-sampling ratio (OSR), the discrete-time impulse response is, for example:

$$h [ n ] = g ( ( n + 0.5 ) Δ T ) , n = - N , … , N - 1 , Δ T = \frac{1}{OSR} \qquad ( 8 )$$

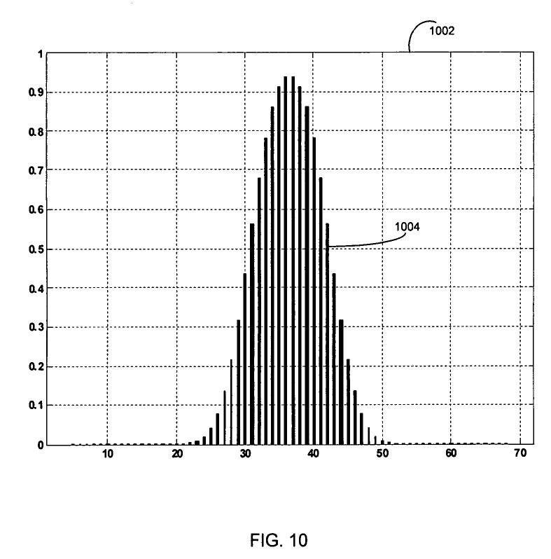

FIG. 10 is a graph 1002 illustrating the discrete-time impulse response waveform 1004 of an example Gaussian filter for the digital modulator 104 of FIG. 1, for example, which may be utilized in connection with an embodiment of the invention. The OSR may be 12, for example, and 2N=72, for example. For convenience, the filter taps may be given positive indices, for example. Notwithstanding, the invention may not be so limited.

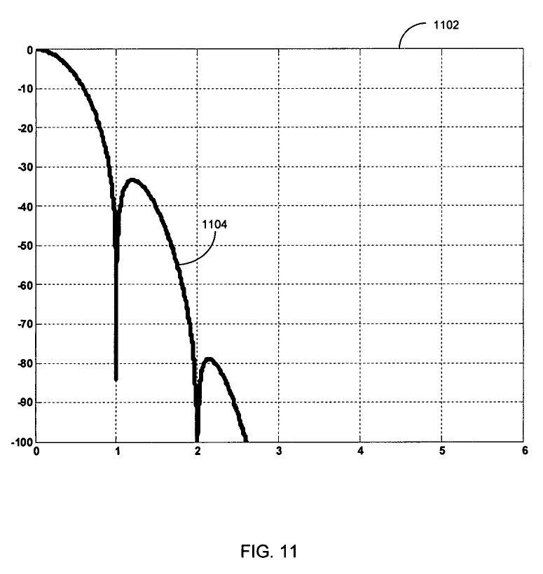

FIG. 11 is a graph 1102 illustrating a magnitude response waveform 1104 of the Gaussian filter of FIG. 10, for example, which may be utilized in connection with an embodiment of the invention.

The quality measures of a transmitter's performance have been established as part of the Bluetooth standard and may be classified into 3 categories, for example, the TX output power spectrum and out-of-band spurious emissions, the modulation characteristics and the RF carrier stability.

The TX output power spectrum and out-of-band spurious emissions quality measures may represent the maximum allowable levels of the power spectrum and spurious emissions as a function of frequency offset from the RF carrier in order for a given transmitter to qualify for Bluetooth certification. These requirements may limit the amount of transmitter signal leakage into other users spectrum and RF bands. For example, a 20 dB bandwidth requirement may require a transmitter to transmit random data and the output power spectrum may be measured with a measurement bandwidth of 30 kHz, for example. The highest power value in the transmit channel may be determined. The lowest frequency below the carrier frequency at which transmit power drops 20 dB below the highest power value may be determined and may be represented as f_{L}. The highest frequency above the carrier frequency at which transmit power drops 20 dB below the highest power value may be determined and may be represented as f_{H}. The difference between the frequencies Δf=f_{H}−f_{L} may be measured. The frequency values f_{H} and f_{L} may satisfy a condition, for example, Δf≦1.0 MHz.

The modulation characteristics quality measures may set requirements on the quality of the frequency modulation. Frequency shift keying (FSK) modulation may imply that the carrier may be frequency modulated around a constant RF carrier frequency, f_{c}. The frequency deviation is the deviation of the modulated signal relative to f_{c}. A plurality of TX data test sequences may be used in quantifying modulation characteristics, for example, test-sequence-1, where the data may be a repeated sequence 00001111 . . . and test-sequence-2, where the data may be a repeated sequence 01010101 . . . .

To quantify the performance of a transmitter, the following test procedure may be utilized. The tester may calculate the average frequency over the frequency values of the 8 bits for each test-sequence-1 8 bit sequence in the payload. Each bit may be oversampled at least four times, for example, to determine the correct deviation value of each bit. The average of at least four samples at the deviation for each bit may be calculated. For each second, third, sixth, and seventh of the 8 bits the deviation from the average frequency within the bit period may be recorded as Δf1ₘₐₓ.

Similarly, the tester may calculate the average frequency over the frequency values of the 8 bits for each test-sequence-2 8 bit sequence in the payload. The average of the frequency values of the 8 bits at the deviation may be calculated. For each of the 8 bits the maximum deviation from the average frequency within the bit period may be recorded as Δf2ₘₐₓ.

The average frequency within the bit period for the two test-sequences may be calculated for at least 10 data packets, for example, and the averages of the Δf1ₘₐₓ and Δf2ₘₐₓ values may be recorded as Δf1_{avg} and Δf2_{avg}, respectively. The calculated values may satisfy the following conditions in accordance with the Bluetooth specification.
140 kHZ≦Δf1ₘₐₓ≦175 kHz for at least 99.9% of all Δf1ₘₐₓ C1)
Δf2ₘₐₓ≦115 kHz for at least 99.9% of all Δf2ₘₐₓ C2)
Δf2_{avg}/Δf1_{avg}≧0.8 C3)

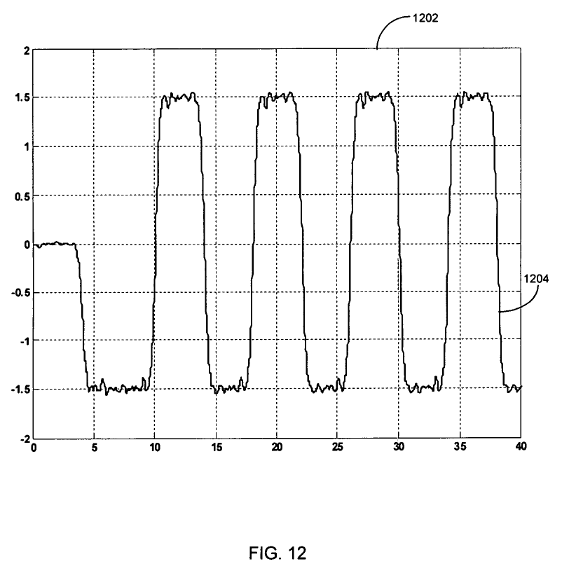

FIG. 12 is a graph 1202 illustrating a demodulated test-sequence-1 data waveform 1204 for a transmitter with a conventional Gaussian filter, which may be utilized in connection with an embodiment of the invention. In this case, Δf1_{avg}=150 kHz, for example.

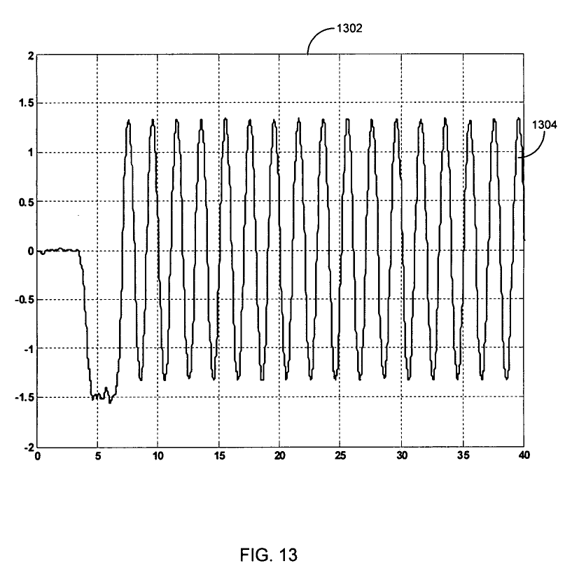

FIG. 13 is a graph 1302 illustrating a demodulated test-sequence-2 data waveform 1304 for a transmitter with a conventional Gaussian filter, which may be utilized in connection with an embodiment of the invention. In this case, Δf2_{avg}=129 kHz, for example. The ratio may be calculated as Δf2_{avg}/Δf1_{avg}=0.86, for example, for this transmitter.

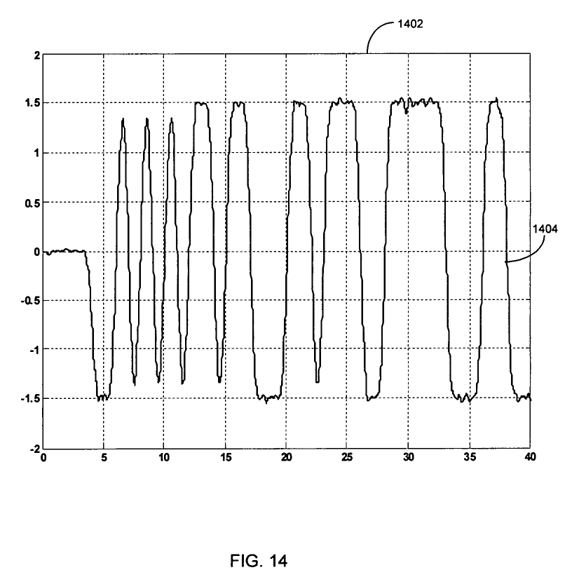

FIG. 14 is a graph 1402 illustrating a demodulated random data waveform 1404 for a transmitter with a conventional Gaussian filter, which may be utilized in connection with an embodiment of the invention.

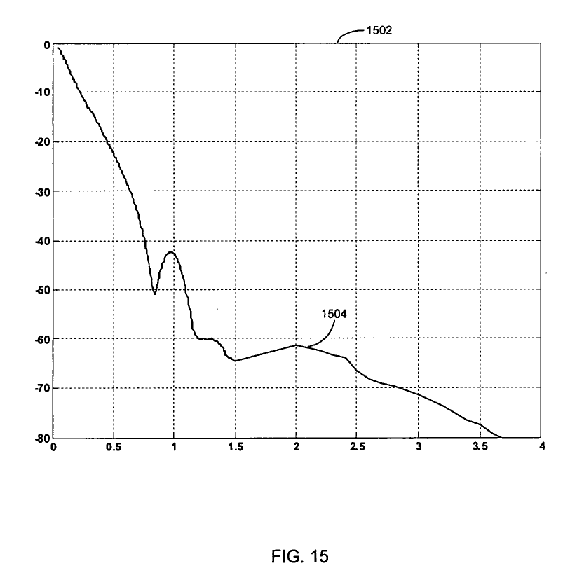

FIG. 15 is a graph 1502 illustrating the RF output signal power spectrum waveform 1504 corresponding to random data for a transmitter with a conventional Gaussian filter, which may be utilized in connection with an embodiment of the invention. The 20 dB bandwidth is 900 kHz, for example.

A GFSK Bluetooth transmitter with a conventional Gaussian filter may satisfy the Δf2_{avg}/Δf1_{avg} requirement of the modulation characteristics with a relatively small margin while the 20 dB bandwidth requirement may be satisfied with quite a large margin. In the presence of non-ideal circuit behavior of the transmitter, such as DC offsets, I-Q imbalance and phase noise, for example, the measured Δf2_{avg}/Δf1_{avg} may be reduced further and may not satisfy requirements if non-ideal circuit behavior is significant.

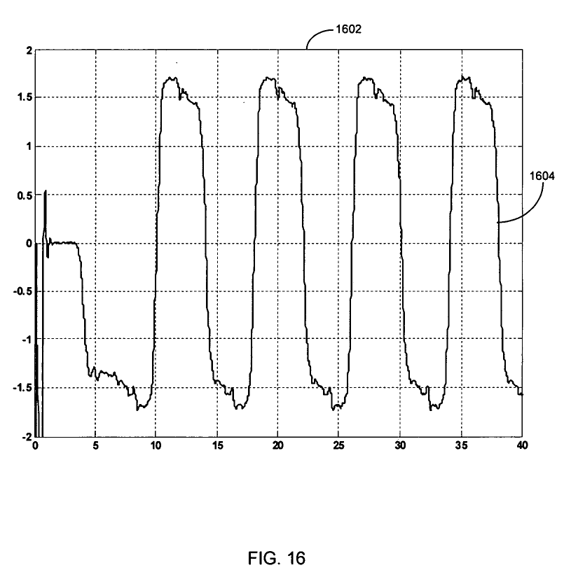

FIG. 16 is a graph 1602 illustrating a worst-case modulation characteristics waveform 1604 for a transmitter employing a Gaussian filter with DC offsets in the in-phase path (I), which may be utilized in connection with an embodiment of the invention.

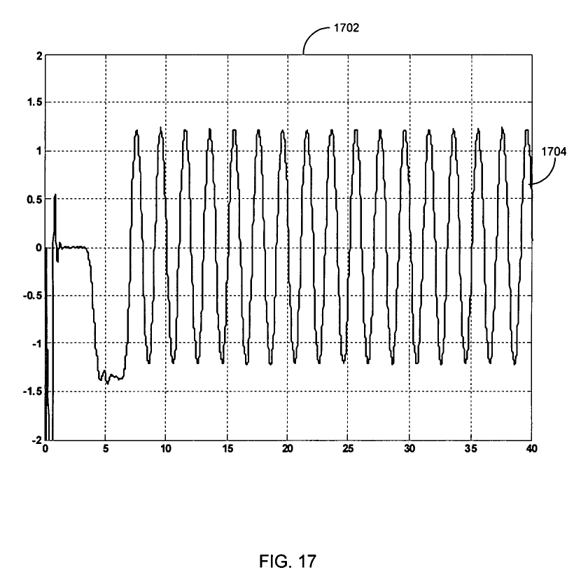

FIG. 17 is a graph 1702 illustrating a worst-case modulation characteristics waveform 1704 for a transmitter employing a Gaussian filter with DC offsets in the quadrature path (Q), which may be utilized in connection with an embodiment of the invention. The DC offset on each path of transmitter may be 7%, for example, relative to full-scale signal swing. Referring to FIG. 16 and FIG. 17, Δf1_{avg}=158 kHz and Δf2_{avg}=121 kHz, for example, respectively. For this transmitter the Δf2_{avg}/Δf1_{avg} ratio may be calculated as, Δf2_{avg}/Δf1_{avg}=0.77, and the modulation characteristics requirement is not met.

An embodiment of the invention provides an algorithm for modifying an impulse response of a Gaussian pulse shaping filter in Bluetooth transmitters in order to increase the ratio Δf2_{avg}/Δf1_{avg} so as to increase the robustness of the transmitter towards non-ideal circuit behavior such as DC offsets. This improvement may occur while satisfying the 20 dB bandwidth requirement.

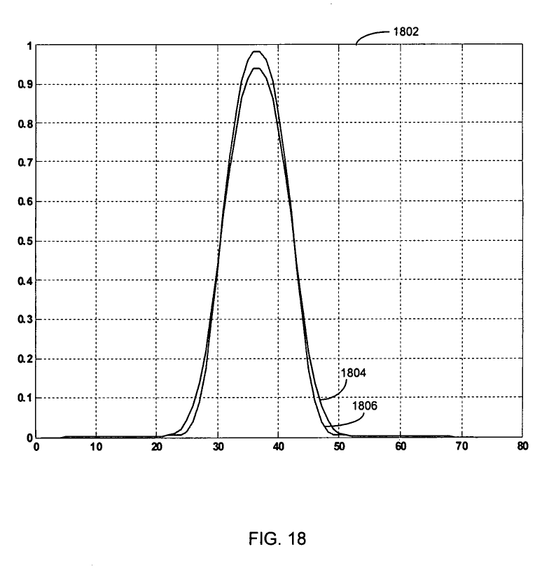

FIG. 18 is a graph 1802 illustrating an impulse response waveform 1804 of the conventional Gaussian filter and an impulse response waveform 1806 of an example modified Gaussian filter, which may be utilized in connection with an embodiment of the invention.

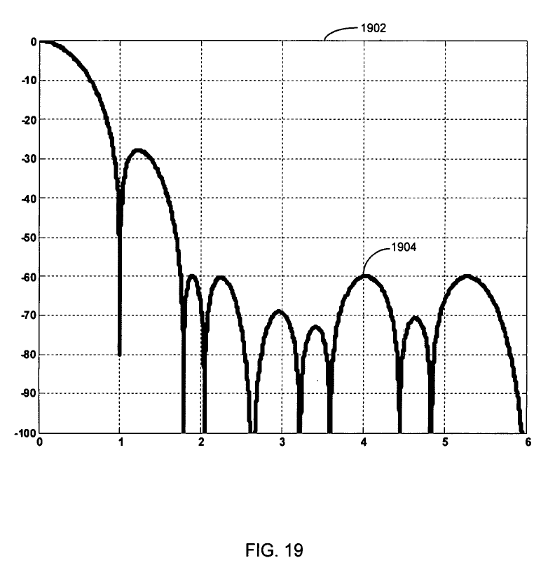

FIG. 19 is a graph 1902 illustrating a magnitude response waveform 1904 of an example modified Gaussian filter of FIG. 19, for example, in accordance with an embodiment of the invention.

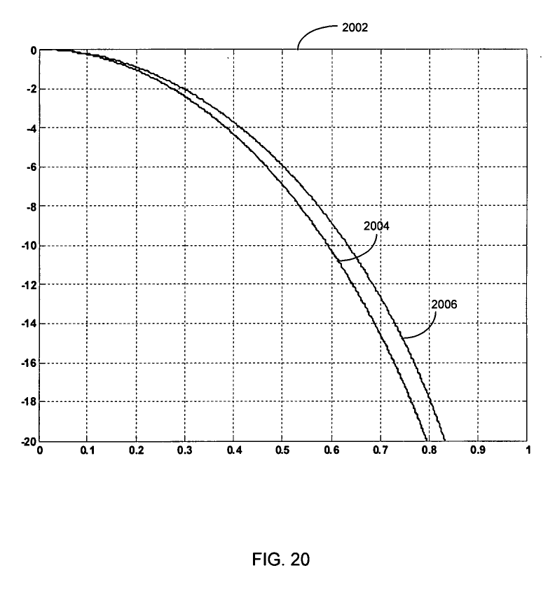

FIG. 20 is a graph 2002 illustrating a magnitude response waveform 2004 of the conventional Gaussian filter and a magnitude response waveform 2006 of an example modified Gaussian filter, which may be utilized in connection with an embodiment of the invention.

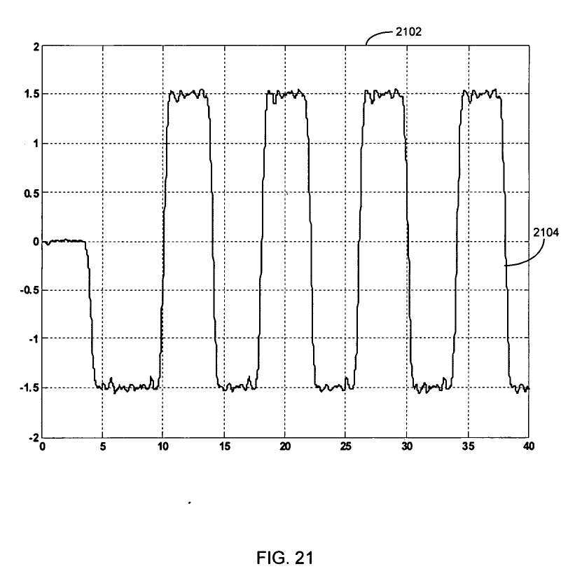

FIG. 21 is a graph 2102 illustrating a demodulated test-sequence-1 data waveform 2104 for a transmitter with a Gaussian filter modified in accordance with an embodiment of the present invention. Referring to FIG. 21, Δf1_{avg}=150 kHz.

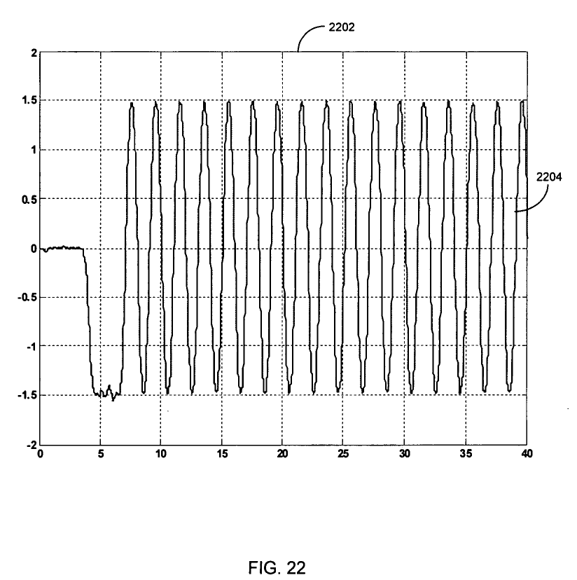

FIG. 22 is a graph 2202 illustrating a demodulated test-sequence-2 data waveform 2204 for a transmitter with a Gaussian filter modified in accordance with an embodiment of the present invention. Referring to FIG. 22, Δf2_{avg}=147 kHz. For this transmitter, Δf2_{avg}/Δf1_{avg}=0.98, and the requirement is met with substantial margin.

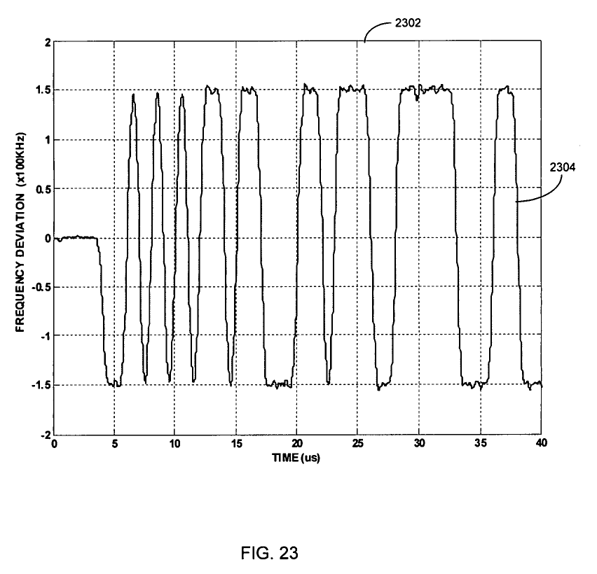

FIG. 23 is a graph 2302 illustrating a demodulated random data waveform 2304 for a transmitter with a Gaussian filter modified in accordance with an embodiment of the present invention.

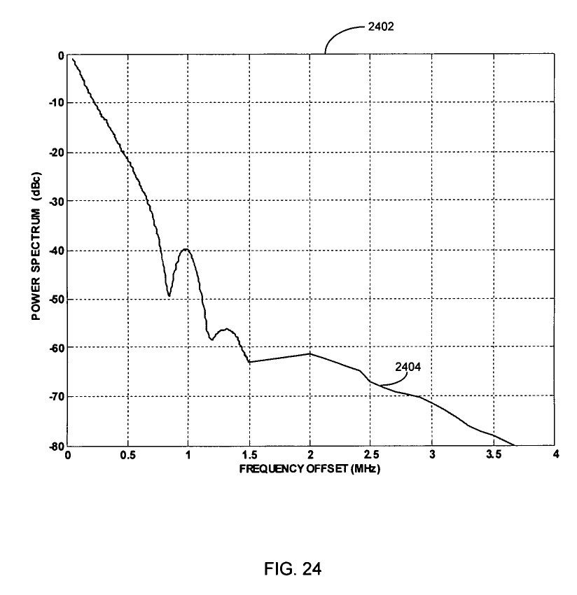

FIG. 24 is a graph 2402 illustrating the RF output signal power spectrum waveform 2404 corresponding to random data for a transmitter with a Gaussian filter modified in accordance with an embodiment of the present invention. The 20 dB bandwidth is 930 kHz, for example.

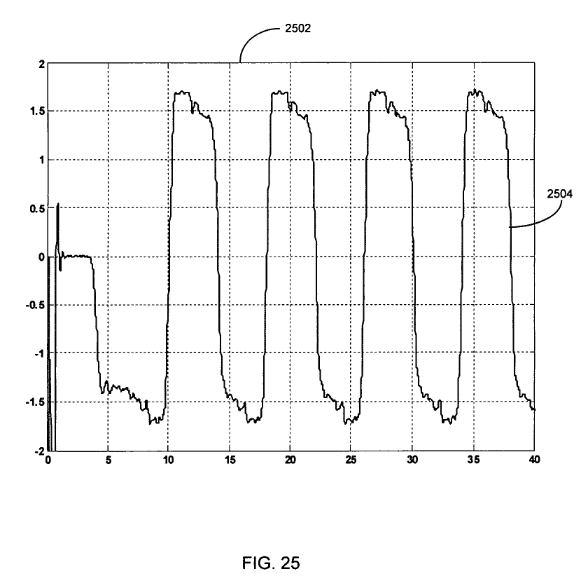

FIG. 25 is a graph 2502 illustrating a demodulated test-sequence-1 data waveform 2504 for a transmitter with a Gaussian filter modified in accordance with an embodiment of the present invention. Referring to FIG. 25, the DC offsets in the I and Q paths of the transmitter may be equal to the DC offsets in FIG. 16. In this case, Δf1_{avg}=158 kHz.

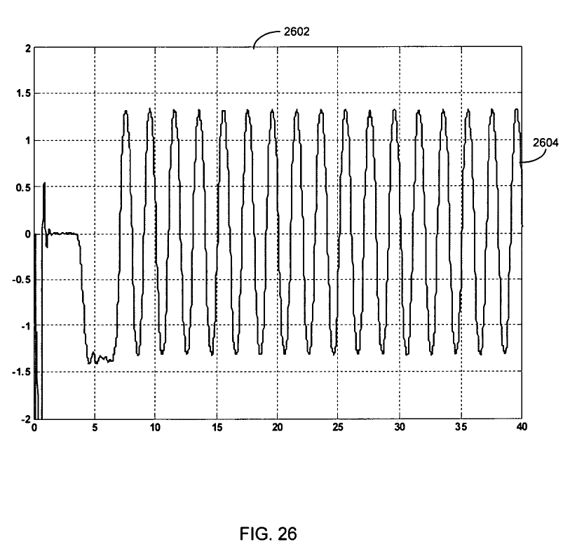

FIG. 26 is a graph 2602 illustrating a demodulated test-sequence-2 data waveform 2604 for a transmitter with a Gaussian filter modified in accordance with an embodiment of the present invention. Referring to FIG. 26, the DC offsets in the I and Q paths of the transmitter may be equal to the DC offsets in FIG. 17. In this case, Δf2_{avg}=132 kHz. For this transmitter, Δf2_{avg}/Δf1_{avg}=0.84, and the modulation characteristics requirement may be met with margin. Hence, the transmitter may be substantially more robust against non-ideal circuit behavior.

In accordance with an embodiment of the invention, a proposed filter design algorithm utilized to generate an improved Gaussian pulse shaping filter may be as illustrated below. An embodiment of the invention may comprise viewing the filter design problem as a constrained multi-variable optimization problem, utilizing the conventional Gaussian filter as the initial value for the design problem. A plurality of exemplary steps may be utilized to modify the existing Gaussian filter to create a new target filter in accordance with an embodiment of the invention.

In step 1, given values of desired filter length, 2N, for example, and oversampling ratio (OSR), the impulse response of a conventional Gaussian filter may be calculated and represented as h₀[n], n=1, . . . , 2N

In step 2, filter coefficient modification of a target filter h_{M}[n] may be performed for a limited set representing most significant coefficients of the conventional Gaussian filter. The initial value of the target filter may be defined by

$${h}_{M} [ n ] = \{ \begin{matrix}{h}_{0} [ n ] , n = 1 … N - {N}_{L} , N + {N}_{L} + 1 … 2 N & (* ) & \\ {h}_{0} [ n ] , n = N - {N}_{L} + 1 , … , N + {N}_{L} & (* *) & \end{matrix} \qquad ( 9 )$$

where N_{L} may represent the number of optimization variables, which may be a set of the most significant coefficients of the first Gaussian filter, (*) may denote filter design constants and (**) may denote filter design variables. Due to filter symmetry, there may be N_{L} design variables.

In step 3, acceptable upper and lower limits for filter coefficient deviation may be determined, such that
x_{L}×h₀[n]≦h_{M}[n]≦x_{U}×h₀[n], ∀n (10)
where h_{M}[n], n=1, . . . , 2N may be impulse response of the target filter, h₀[n], n=1, . . . , 2N may be impulse response of the Gaussian filter, x_{L} may be lower limit for deviation and x_{U} may be upper limit for deviation.

In step 4, a modified filter magnitude response may be defined by
|H_{M}(e^{j2πf}^{_{c}})|≡|H_{M}(e^{jπ/OSR})| (11)
where H_{M} may be impulse response of the target filter and f_{C} may be a selected corner frequency, for example, 500 kHz.

In step 5, as h_{M}[n] may be employed as an interpolation filter, the magnitude response may be constrained at integer multiples of the discrete-time image frequency 1/OSR, for example. If h_{M}[n] is not constrained at integer multiples of the discrete-time image frequency 1/OSR, it may exhibit steady-state ringing, which may negatively affect the modulation characteristics. For frequencies equal to and above twice the corner frequency, for example, a magnitude constraint may be
|H_{M}(e^{j2πf})|≦A_{STOP}, ∀f≧2f_{c} (12)
where H_{M} may be impulse response of the target filter, f may be a frequency of operation, f_{C} may be a selected corner frequency and A_{STOP} may be a final magnitude of the magnitude response of the target filter.

In step 6, a line search algorithm may be applied to the N_{L}-variable constrained magnitude response to generate new coefficients for said target filter.
min{1−|H_{M}(e^{j2πf}^{_{c}})|} (13)
with an initial value of the target filter as

$${h}_{M} [ n ] = \{ \begin{matrix}{h}_{0} [ n ] , n = 1 … N - {N}_{L} , N + {N}_{L} + 1 … 2 N & (* ) & & \\ {h}_{0} [ n ] , n = N - {N}_{L} + 1 , … , N + {N}_{L} & (* *) & & \end{matrix}$$

and subject to x_{L}×h₀[n]≦h_{M}[n]≦x_{U}×h₀[n], ∀ n and |H_{M}(e^{j2πf})|≦A_{STOP}, ∀ f≧2f_{c}, where h_{M}[n],n=1, . . . ,2N may be impulse response of the target filter, h₀[n],n=1, . . . ,2N may be impulse response of the Gaussian filter, N_{L} may represent number of optimization variables, which may be a set of the most significant coefficients of the first Gaussian filter, (*) may denote filter design constants, (**) may denote filter design variables, x_{L} may be lower limit for deviation, x_{U} may be upper limit for deviation, H_{M} may be impulse response of the target filter, f may be a frequency of operation, f_{C} may be a selected corner frequency and A_{STOP} may be a final magnitude of the magnitude response of the target filter. For the exemplary transmitter of FIG. 2, the following are exemplary values that may be utilized for equation (13):

TABLE 1
2N = 72, OSR = 12, N_{L} = 20,
x_{L} = 25%, x_{U} = 150%, A_{STOP} = −60 dB

| Conventional Gaussian | Target Gaussian |
|---|---|
| filter coefficients | filter coefficients |
| 0.00000000000000 | 0.00000000000000 |
| 0.00000000000000 | 0.00000000000000 |
| 0.00000000000000 | 0.00000000000000 |
| 0.00000000000000 | 0.00000000000000 |
| 0.00000000000000 | 0.00000000000000 |
| 0.00000000000001 | 0.00000000000001 |
| 0.00000000000007 | 0.00000000000006 |
| 0.00000000000075 | 0.00000000000061 |
| 0.00000000000686 | 0.00000000000559 |
| 0.00000000005731 | 0.00000000004666 |
| 0.00000000043435 | 0.00000000035366 |
| 0.00000000298881 | 0.00000000243356 |
| 0.00000001867660 | 0.00000001520694 |
| 0.00000010601085 | 0.00000008631662 |
| 0.00000054674063 | 0.00000044516958 |
| 0.00000256292207 | 0.00000208679375 |
| 0.00001092396943 | 0.00000222364068 |
| 0.00004235581294 | 0.00000862178436 |
| 0.00014947349155 | 0.00003042624192 |
| 0.00048040520177 | 0.00057077528730 |
| 0.00140724593017 | 0.00171872101208 |
| 0.00376047733129 | 0.00307230461599 |
| 0.00917699278401 | 0.00343449298926 |
| 0.02047947642601 | 0.00416872247834 |
| 0.04186050983134 | 0.01103260141850 |
| 0.07852842466480 | 0.03818038156130 |
| 0.13553791802600 | 0.08840347565050 |
| 0.21589228853008 | 0.17328803879488 |
| 0.31856680230528 | 0.29170465259226 |
| 0.43749079428481 | 0.42804484720541 |
| 0.56231737641062 | 0.57496411098901 |
| 0.68094186852278 | 0.71043366306417 |
| 0.78269790261082 | 0.82450605244877 |
| 0.86070105784478 | 0.90565410992147 |
| 0.91229447610599 | 0.95964882335029 |
| 0.93765999207724 | 0.98113031862647 |

Table 1 illustrates exemplary filter coefficients of the conventional Gaussian filter and the target Gaussian filter defined by (5) and (6) that may be utilized in connection with an embodiment of the invention. Due to filter symmetry, 36 tap values are listed. FIG. 11 illustrates the magnitude response of a conventional Gaussian filter with filter coefficients as shown in column 1 of Table 1 that may be utilized in connection with an embodiment of the invention.

By applying the filter design algorithm to the conventional Gaussian filter with filter coefficients as shown in column 1 of Table 1, the target Gaussian filter with filter coefficients as shown in column 2 of Table 1 may be generated. FIG. 19 illustrates the magnitude response of the target Gaussian filter with filter coefficients as shown in column 2 of Table 1, in accordance with an embodiment of the invention. FIG. 20 compares the magnitude responses of the two filters in the frequency range 0-1 MHz, in accordance with an embodiment of the invention.

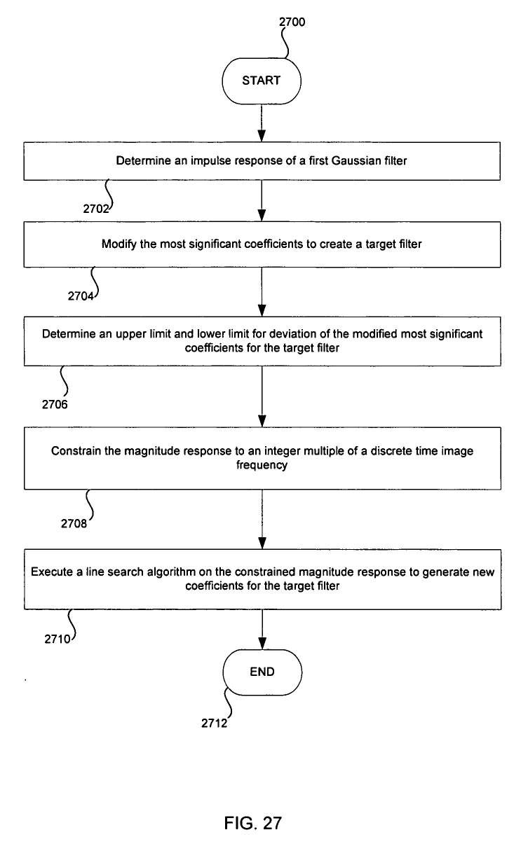

FIG. 27 is a flowchart illustrating exemplary steps that may be utilized for Gaussian filter modification, in accordance with an embodiment of the invention. Referring to FIG. 27, exemplary steps may start at step 2700. In step 2702, an impulse response of a first Gaussian filter h₀[n],n=1, . . . ,2N may be determined based on a filter length, for example, 2N and an oversampling ratio (OSR). In step 2704, the most significant coefficients of the first Gaussian filter may be modified to create a target filter. In step 2706, an upper limit and a lower limit for deviation of the modified most significant coefficients for the target filter may be determined. x_{L}×h₀[n]≦h_{M}[n]≦x_{U} ×h₀[n], ∀ n, where h_{M}[n], n=1, . . .,2N is the impulse response of the target filter, h₀[n],n=1, . . . ,2N is the impulse response of the first Gaussian filter, x_{L} is the lower limit for deviation and x_{U} is the upper limit for deviation.

In step 2708, magnitude response for the target filter may be constrained in integer multiples of a discrete time image frequency, which is a reciprocal of the OSR. The magnitude response of the target filter may be such that |H_{M}(e^{j2πf}^{_{c}})|≡|H_{M}(e^{jπ/OSR})|, where H_{M} is the impulse response of the target filter and f_{C} is the selected corner frequency. The magnitude response of the target filter may be constrained by |H_{M}(e^{j2πf})|≦A_{STOP}, ∀ f≧2f_{c}, where H_{M} is the impulse response of the target filter, f is a frequency of operation, f_{C} is the selected corner frequency and A_{STOP} is a final magnitude of the magnitude response of the target filter.

In step 2710, a line search algorithm may be executed on the constrained magnitude response to generate new coefficients for the target filter, wherein the line search algorithm is given by min{1−|H_{M}(e^{j2πf}^{_{c}})|}, wherein an initial value of the target filter is

$${h}_{M} [ n ] = \{ \begin{matrix}{h}_{0} [ n ] , n = 1 … N - {N}_{L} , N + {N}_{L} + 1 … 2 N & (* ) & & \\ {h}_{0} [ n ] , n = N - {N}_{L} + 1 , … , N + {N}_{L} & (* *) & & \end{matrix}$$

and subject to x_{L}×h₀[n]≦h_{M}[n]≦x_{U}×h₀[n], ∀ n and |H_{M}(e^{j2πf})|≦A_{STOP}, ∀ f≧2f_{c}, where h_{M}[n],n=1, . . . ,2N is the impulse response of the target filter, h₀[n],n=1, . . . ,2N is the impulse response of the Gaussian filter, N_{L} represents number of optimization variables, which is a set of the most significant coefficients of the first Gaussian filter, (*) denotes filter design constants, (**) denotes filter design variables, x_{L} is the lower limit for deviation, x_{U} is the upper limit for deviation, H_{M} is the impulse response of the target filter, f is a frequency of operation, f_{C} is the selected corner frequency and A_{STOP} is a final magnitude of the magnitude response of the target filter. Control then passes to end step 2712.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for generating a filter with improved modulation characteristics in a communications system, the method comprising:
determining an impulse response of a first Gaussian filter based on a filter length and an oversampling ratio (OSR);
modifying most significant coefficients of said first Gaussian filter to create a target filter;
determining an upper limit and a lower limit for deviation of said modified most significant coefficients for said target filter;
constraining a magnitude response for said target filter based on at least a selected corner frequency, which is related to said OSR; and
executing a line search algorithm on said constrained magnitude response to generate new coefficients for said target filter.

2. The method according to claim 1, further comprising constraining said magnitude response to an integer multiple of a discrete time image frequency, which is a reciprocal of said OSR.

3. The method according to claim 1, wherein an initial value of said target filter is
$${h}_{M} [ n ] = \{ \begin{matrix}{h}_{0} [ n ] , n = 1 … N - {N}_{L} , N + {N}_{L} + 1 … 2 N & & & \\ {h}_{0} [ n ] , n = N - {N}_{L} + 1 , … , N + {N}_{L} , & & & \end{matrix}$$
where h_{M}[n],n=1, . . . ,2N is said impulse response of said target filter, h₀[n],n=1, . . . ,2N is said impulse response of said Gaussian filter, N_{L} represents number of optimization variables, which is a set of said most significant coefficients of said first Gaussian filter.

4. The method according to claim 1, wherein said upper limit and said lower limit for deviation of said modified most significant coefficients for said target filter is x_{L}×h₀[n]≦h_{M}[n]≦x_{U}×h₀[n], ∀ n, where h_{M}[n],n=1, . . . ,2N is said impulse response of said target filter, h₀[n],n=1, . . . ,2N is said impulse response of said Gaussian filter, x_{L} is said lower limit for deviation and x_{U} is said upper limit for deviation.

5. The method according to claim 1, wherein said magnitude response of said target filter is |H_{M}(e^{j2πf})|≡|H_{M}(e^{jπ/OSR})|,where H_{M} is said impulse response of said target filter and f_{C} is said selected corner frequency.

6. The method according to claim 1, wherein said magnitude response of said target filter is constrained by |H_{M}(e^{j2πf})|≦A_{STOP}, ∀ f≧2f_{c}, where H_{M} is said impulse response of said target filter, f is a frequency of operation, f_{C} is said selected corner frequency and A_{STOP} is a final magnitude of said magnitude response of said target filter.

7. The method according to claim 1, wherein said line search algorithm is applied to a minimization problem given by min{1−|H_{M}(e^{j2πf}^{_{c}})|}, wherein an initial value of said target filter is
$${h}_{M} [ n ] = \{ \begin{matrix}{h}_{0} [ n ] , n = 1 … N - {N}_{L} , N + {N}_{L} + 1 … 2 N & & & \\ {h}_{0} [ n ] , n = N - {N}_{L} + 1 , … , N + {N}_{L} , & & & \end{matrix}$$
and subject to x_{L}×h₀[n]≦h_{M}[n]≦x_{U}×h₀[n], ∀ n and |H_{M}(e^{j2πf})|≦A_{STOP}, ∀ f≧2f_{c}where h_{M[n],n=}1, . . . ,2N is said impulse response of said target filter, h₀[n],n=1, . . . ,2N is said impulse response of said Gaussian filter, N_{L} represents number of optimization variables, which is a set of said most significant coefficients of said first Gaussian filter, x_{L} is said lower limit for deviation, x_{U} is said upper limit for deviation, H_{M} is said impulse response of said target filter, f is a frequency of operation, f_{C} is said selected corner frequency and A_{STOP} is a final magnitude of said magnitude response of said target filter.

8. A machine-readable storage having stored thereon, a computer program having at least one code section for generating a filter with improved modulation characteristics in a communications system, the at least one code section being executable by a machine for causing the machine to perform steps comprising:
determining an impulse response of a first Gaussian filter based on a filter length and an oversampling ratio (OSR);
modifying most significant coefficients of said first Gaussian filter to create a target filter;
determining an upper limit and a lower limit for deviation of said modified most significant coefficients for said target filter;
constraining a magnitude response for said target filter based on at least a selected corner frequency, which is related to said OSR; and
executing a line search algorithm on said constrained magnitude response to generate new coefficients for said target filter.

9. The machine-readable storage according to claim 8, further comprising code for constraining said magnitude response to an integer multiple of a discrete time image frequency, which is a reciprocal of said OSR.

10. The machine-readable storage according to claim 8, wherein an initial value of said target filter is
$${h}_{M} [ n ] = \{ \begin{matrix}{h}_{0} [ n ] , n = 1 … N - {N}_{L} , N + {N}_{L} + 1 … 2 N \\ {h}_{0} [ n ] , n = N - {N}_{L} + 1 , … , N + {N}_{L}\end{matrix} ,$$
where h_{M}[n],n=1, . . . ,2N is said impulse response of said target filter, h₀[n],n=1, . . . ,2N is said impulse response of said Gaussian filter, N_{L} represents number of optimization variables, which is a set of said most significant coefficients of said first Gaussian filter.

11. The machine-readable storage according to claim 8, wherein said upper limit and said lower limit for deviation of said modified most significant coefficients for said target filter is x_{L}×h₀[n]≦h_{M}[n]≦x_{U}×h₀[n], ∀ n, where h_{M}[n], n=1, . . . ,2N is said impulse response of said target filter, h₀[n],n=1, . . . ,2N is said impulse response of said Gaussian filter, x_{L} is said lower limit for deviation and x_{U} is said upper limit for deviation.

12. The machine-readable storage according to claim 8, wherein said magnitude response of said target filter is |H_{M}(e^{j2πf}^{_{c}})|≡|H_{M}(e^{jπ/OSR})|, where H_{M} is said impulse response of said target filter and f_{C} is said selected corner frequency.

13. The machine-readable storage according to claim 8, wherein said magnitude response of said target filter is constrained by |H_{M}(e^{j2πf})|≦A_{STOP}, ∀ f≧2f_{c}, where H_{M} is said impulse response of said target filter, f is a frequency of operation, f_{C} is said selected corner frequency and A_{STOP} is a final magnitude of said magnitude response of said target filter.

14. The machine-readable storage according to claim 8, wherein said line search algorithm is applied to a minimization problem given by min{1−|H_{M}(e^{j2πf}^{_{c}})|}, wherein an initial value of said target filter is
$${h}_{M} [ n ] = \{ \begin{matrix}{h}_{0} [ n ] , n = 1 … N - {N}_{L} , N + {N}_{L} + 1 … 2 N \\ {h}_{0} [ n ] , n = N - {N}_{L} + 1 , … , N + {N}_{L}\end{matrix}$$
and subject to x_{L}×h₀[n]≦h_{M}[n]≦x_{U}×h₀[n], ∀ n and |H_{M}(e^{j2πf})|≦A_{STOP}, ∀ f ≧2f_{c}, where h_{M}[n],n=1, . . . ,2N is said impulse response of said target filter, h₀[n],n=1, . . . ,2N is said impulse response of said Gaussian filter, N_{L} represents number of optimization variables, which is a set of said most significant coefficients of said first Gaussian filter, x_{L} is said lower limit for deviation, x_{U} is said upper limit for deviation, H_{M} is said impulse response of said target filter, f is a frequency of operation, f_{C} is said selected corner frequency and A_{STOP} is a final magnitude of said magnitude response of said target filter.

15. A system for generating a filter with improved modulation characteristics in a communications system, the system comprising:
circuitry that determines an impulse response of a first Gaussian filter based on a filter length and an oversampling ratio (OSR);
circuitry that modifies most significant coefficients of said first Gaussian filter to create a target filter;
circuitry that determines an upper limit and a lower limit for deviation of said modified most significant coefficients for said target filter;
circuitry that constrains a magnitude response for said target filter based on at least a selected corner frequency, which is related to said OSR; and
circuitry that executes a line search algorithm on said constrained magnitude response to generate new coefficients for said target filter.

16. The system according to claim 15, further comprising circuitry that constrains said magnitude response to an integer multiple of a discrete time image frequency, which is a reciprocal of said OSR.

17. The system according to claim 15, wherein an initial value of said target filter is
$${h}_{M} [ n ] = \{ \begin{matrix}{h}_{0} [ n ] , n = 1 … N - {N}_{L} , N + {N}_{L} + 1 … 2 N \\ {h}_{0} [ n ] , n = N - {N}_{L} + 1 , … , N + {N}_{L}\end{matrix} ,$$
where h_{M}[n],n=1, . . . ,2N is said impulse response of said target filter, h₀[n],n=1, . . . ,2N is said impulse response of said Gaussian filter, N_{L} represents number of optimization variables, which is a set of said most significant coefficients of said first Gaussian filter.

18. The system according to claim 15, wherein said upper limit and said lower limit for deviation of said modified most significant coefficients for said target filter is x_{L}×h₀[n]≦h_{M}[n]≦x_{U}×h₀[n], ∀ n, where h_{M}[n],n=1, . . . ,2N is said impulse response of said target filter, h₀[n],n=1, . . . ,2N is said impulse response of said Gaussian filter, x_{L} is said lower limit for deviation and x_{U} is said upper limit for deviation.

19. The system according to claim 15, wherein said magnitude response of said target filter is |H_{M}(e^{j2π}^{_{c}})|≡|H_{M}(e^{jπ/OSR})|, where H_{M} is said impulse response of said target filter and f_{C} is said selected corner frequency.

20. The system according to claim 15, wherein said magnitude response of said target filter is constrained by |H_{M}(e^{j2πf})|≦A_{STOP}, ∀ f≧2f_{c}, where H_{M} is said impulse response of said target filter, f is a frequency of operation, f_{C} is said selected corner frequency and A_{STOP} is a final magnitude of said magnitude response of said target filter.

21. The system according to claim 15, wherein said line search algorithm is applied to a minimization problem given by min{1−|H_{M}(e^{j2πf}^{_{c}})|}, wherein an initial value of said target filter is
$${h}_{M} [ n ] = \{ \begin{matrix}{h}_{0} [ n ] , n = 1 … N - {N}_{L} , N + {N}_{L} + 1 … 2 N \\ {h}_{0} [ n ] , n = N - {N}_{L} + 1 , … , N + {N}_{L}\end{matrix}$$
and subject to x_{L}×h₀[n]≦h_{M}[n]≦x_{U}×h₀[n], ∀ n and |H_{M}(e^{j2πf})|≦A_{STOP}, ∀ f≧2f_{c}, where h_{M}[n],n=1, . . . ,2N is said impulse response of said target filter, h₀[n],n=1, . . . ,2N is said impulse response of said Gaussian filter, N_{L} represents number of optimization variables, which is a set of said most significant coefficients of said first Gaussian filter, x_{L} is said lower limit for deviation, x_{U} is said upper limit for deviation, H_{M} is said impulse response of said target filter, f is a frequency of operation, f_{C} is said selected corner frequency and A_{STOP} is a final magnitude of said magnitude response of said target filter.
